(19) United States
(12) Patent Application Publication
(10) Pub. No.: US 2009/0141138 A1
(43) Pub. Date: Jun. 4, 2009

(54) System And Methods For Capturing Images Of An Event

(76) Inventor: Douglas J. DeAngelis, Ipswich, MA (US)

Correspondence Address: LATHROP & GAGE LLP, 4845 PEARL EAST CIRCLE, SUITE 201, BOULDER, CO, 80301, US

(21) Appl. No.: 12/328,519

(22) Filed: Dec. 4, 2008

Related U.S. Application Data
(63) Continuation-in-part of application No. 11/950,346, filed on Dec. 4, 2007.
Application No. 11/950,346 is a continuation-in-part of application No. PCT/US07/86420, filed on Dec. 4, 2007.
(60) Provisional application No. 60/872,639, filed on Dec. 4, 2006.
(60) Provisional application No. 60/872,639, filed on Dec. 4, 2006.
(60) Provisional application No. 61/045,878, filed on Apr. 17, 2008.

(51) Int. Cl. H04N 5/225; H04N 5/76

(52) U.S. Cl. 348/220.1; 348/231.5; 348/E05.024

(57) ABSTRACT

A system for capturing images of an event includes at least one data correlator. The data correlator is operable to receive still images captured by a camera and to receive identification/time pairs from a sensor. Each identification/time pair includes an identity of at least one respective object and a time that the at least one respective object was within the camera's field of view. The data correlator is operable to automatically correlate the still images with identities of respective objects included in the still images by correlating an identity of at least one respective object of each identification/time pair to a still image that is closest in time to a time of the identification/time pair.

### RELATED APPLICATIONS

This application is a continuation in part of U.S. patent application Ser. No. 11/950,346 filed 4 Dec. 2007, which claims benefit of priority to U.S. Patent Application Ser. No. 60/872,639, filed 4 Dec. 2006. This application is also a continuation in part of Patent Cooperation Treaty Application number PCT/US2007/086420 filed 4 Dec. 2007, which claims benefit of priority to U.S. Patent Application Ser. No. 60/872,639, filed 4 Dec. 2006. This application also claims benefit of priority to U.S. Provisional Patent Application Ser. No. 61/045,878 filed 17 Apr. 2008. Each of the aforementioned applications are incorporated herein by reference.

### BACKGROUND

Participants in an event, such as a road race, are commonly photographed during the event. One or more professional photographers are typically stationed at the event (e.g., along the course of a road race) to take the photographs. Reviewers manually identify participants pictured in the photographs, and the event organizer or a photography company commonly tries to sell copies of the photographs to the participants.

In a large event, a whole team of professional photographers are typically required to capture even just a few still images of each participant. It can be quite costly to employ such professional photographers—accordingly, it is usually more feasible to capture at most a few photographs of each participant. Additionally, the cost to employ such photographers may even make it cost prohibitive to professionally photograph participants in smaller events.

Participants in an event are also commonly video recorded while participating in the event. Professional camera operators can be employed to operate the required video cameras, or the video cameras can be set up at the event and left largely unattended during the event. One or more reviewers typically review the captured video to identify participants pictured therein. The event organizer or a video recording company commonly tries to sell copies of the recorded video to the participants.

### SUMMARY

In an embodiment, a system for capturing images of an event includes at least one data correlator. The data correlator is operable to receive still images captured by a camera and to receive identification/time pairs from a sensor. Each identification/time pair includes an identity of at least one respective object and a time that the at least one respective object was within the camera's field of view. The data correlator is operable to automatically correlate the still images with identities of respective objects included in the still images by correlating an identity of at least one respective object of each identification/time pair to a still image that is closest in time to a time of the identification/time pair.

In an embodiment, a system for capturing images of an event includes at least one image capture subsystem. Each image capture subsystem includes a camera having a field of view for periodically capturing still images within the camera's field of view. Each image capture subsystem additionally includes a sensor for detecting objects within the camera's field of view and for generating a respective identification/time pair for each detected object. Each identification/time pair includes an identity of a respective object and a time that the sensor detected the respective object. Furthermore, each image capture subsystem includes a data correlator coupled to the camera and the sensor. The data correlator is operable to receive the still images captured by the camera and the identification/time pairs generated by the sensor. The data correlator is also operable to automatically correlate the still images with identities of respective objects included in the still images by correlating an identity of each identification/time pair to a still image that is closest in time to a time of the identification/time pair.

In an embodiment, a method for correlating a still image with an identity of an object pictured in the still image includes receiving an identification/time pair including the object's identity and a time that the object was detected by a sensor. A respective still image having a time stamp closest in time to the time of the identification/time pair is identified, and the identified still image is outputted.

In an embodiment, a software product includes instructions, stored on a computer-readable medium. The instructions, when executed by a computer, perform steps for correlating a still image with an identity of an object pictured in the still image. The steps include (1) instructions for receiving an identification/time pair including the object's identity and a time that the object was detected by a sensor, (2) instructions for identifying a respective still image having a time stamp closest in time to the time of the identification/time pair, and (3) instructions for outputting the identified still image.

### BRIEF DESCRIPTION OF DRAWINGS

FIG. 1 schematically illustrates one system for capturing images of an event, according to an embodiment.

FIG. 2 schematically illustrates one image capture subsystem, according to an embodiment.

FIG. 3 is a flow chart of one method for correlating a still image with the identity of an object pictured in the image, according to an embodiment.

FIG. 4 is a flow chart of another method for correlating a still image with the identity of an object pictured in the image, according to an embodiment.

FIG. 5 schematically illustrates another system for capturing images of an event, according to an embodiment.

FIG. 6 schematically illustrates another image capture subsystem, according to an embodiment.

FIG. 7 is block diagram illustrating one example of a buffer, according to an embodiment.

FIG. 8 illustrates one method for controlling the output of captured still images, according to an embodiment.

### DETAILED DESCRIPTION OF DRAWINGS

Specific instances of an item may be referred to by use of a numeral in parentheses (e.g., image capture subsystem 102(1)) while numerals without parentheses refer to any such item generally (e.g., image capture subsystems 102).

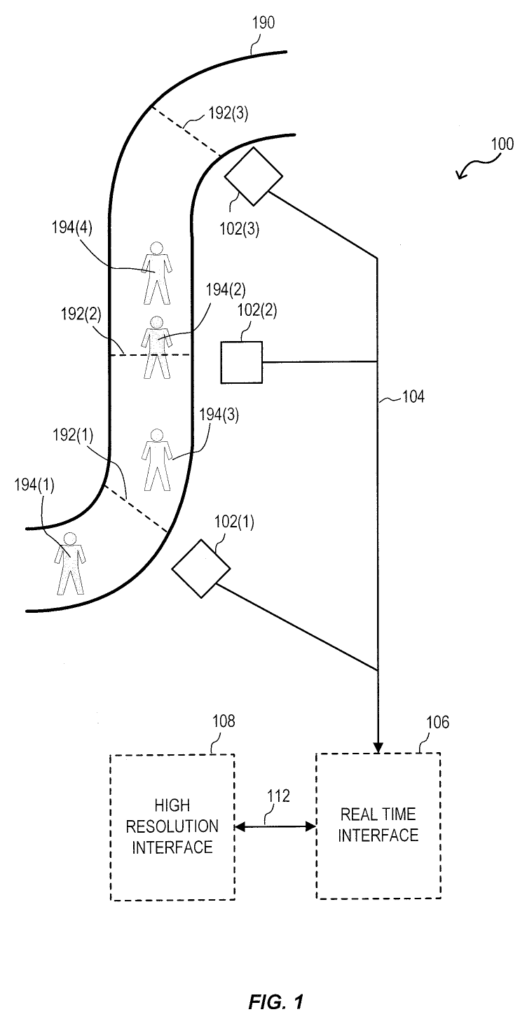

FIG. 1 schematically illustrates one system 100 for capturing images of an event. System 100 is operable to capture a plurality of still images of the event, and is optionally operable to create video clips from such still images. For example, FIG. 1 illustrates system 100 as configured to capture still images of participants or runners 194 participating in a road race along course 190. However, system 100 is not limited to use in road races and may be used to capture images in other events such as track meets, bicycle races, auto races, ski races, horse races, dog races, etc. Some embodiments of system 100 are operable to automatically correlate captured still images and/or video clips with the identity of participants pictured therein, thereby advantageously eliminating the time and cost required to manually perform such correlation.

System 100 includes at least one image capture subsystem 102 for periodically capturing still images of the event. In FIG. 1, system 100 is shown with three image capture subsystems 102(1), 102(2), and 102(3). However, system 100 can have a smaller or larger number of image capture subsystems 102—the number is chosen, for example, based on the number of still images desired of each participant 194 as well as the number of locations where still images are to be captured. Accordingly, system 100 advantageously permits the capture of a large number of still images and/or video clips of the event without the need to employ costly photographers.

Each image capture subsystem 102 operates to periodically capture still images of its field of view and is disposed such that its field of view covers a desired physical portion of the event. In the example of FIG. 1, image capture subsystem 102(1) captures still images of split line 192(1); image capture subsystem 102(2) captures still images of split line 192(2); and image capture subsystem 102(3) captures still images of split line 192(3).

Although FIG. 1 shows image capture subsystems 102 as being stationary, one or more image capture subsystems 102 could be mobile. For example, in the case of a road race, an image capture subsystem 102 could be disposed on a lead vehicle to capture images of lead event participants. As another example, an image capture subsystem 102 could be disposed on an event participant.

The captured still images may be used to form one or more video clips. The video clips, for example, are created in response to user input (e.g., by the user specifying the first and last still images of the video clip), and/or are automatically created.

As discussed below, image capture subsystems 102 are operable to time stamp each still image with the time of the image's capture. Such image capture time is, for example, simply the time of day that the image is captured. As another example, if the event is a road race, image capture subsystems 102 may operate to time stamp each captured still image with its capture time, where the capture time is relative to the start of the race. Additionally, some embodiments of image capture subsystem 102 are operable to annotate each still image with information identifying the particular image capture subsystem 102 that captured the image. Such information may useful to identify in what physical portion of the event the still image was captured.

Furthermore, as discussed below, some embodiments of image capture subsystem 102 are operable to automatically correlate a still image to the identity of an object (e.g., an event participant 194) pictured in the image. Thus, use of system 100 may advantageously eliminate the cost and time required for a human to correlate captured still images with the identity of participants pictured therein. This automatic correlation feature, as supported by some embodiments of image capture subsystem 102, may also extend to video clips—the identity of one or more participants pictured in a video clip is determined from the identity of one or more participants pictured in each of the video clip's constituent still images.

Image capture subsystems 102 may operate as stand alone systems—that is, each image capture subsystem 102 may operate substantially independently of all other systems. In such case, each image capture subsystem 102 internally stores some or all of its captured still images and/or video clips created from such still images for future use.

Alternately, image capture subsystems 102 may be coupled with one or more external systems. In some embodiments of system 100, some or all of the captured still images and/or video clips created from such still images are provided on a real time basis or near real time basis for access via a real time interface 106. If system 100 includes real time interface 106, at least some of the image capture subsystems 102 provide captured still images and/or video clips created from such still images to real time interface 106 via communication medium 104.

Communication medium 104 may represent a single medium as illustrated in FIG. 1; alternately, communication medium 104 may comprise a plurality of independent links, where each link couples one or more image capture subsystems 102 to real time interface 106. For example, each image capture subsystem 102 may couple to real time interface 106 via its own, stand alone communication link. Communication medium 104 includes, for example, one or more of a local area network (e.g., an Ethernet network), a wide area network, and a wireless network.

As noted above, real time interface 106 allows real time or near real time access to at least some still images captured by one or more image capture subsystems 102 and/or video clips created from such still images. Real time interface 106 includes, for example, one or more of a kiosk located at the event, a web portal allowing both local and remote users to access the still images and/or video clips via the world wide web (e.g., via a hyperlink on an official web site of the event), a telecommunications network (e.g., a mobile telephone network allowing a user to access the still images and/or video clips via a mobile phone), and a display (e.g., a scoreboard with image display capability) at the event.

Real time interface 106, for example, allows a user to search for still images and/or video clips that meet one or more desired criteria, such as including an object of interest (e.g., a particular event participant), participant finish time, participant split time, location within the event, etc. For example, if system 100 is used in a road race, real time interface 106 may allow a user to search for still images and/or video clips of a participant by searching by the participant's name, bib number, finish time, split time, etc. The user in this example may step forward and backward through the found still images to find the most desirable still images. Real time interface 106, for example, also allows a user to format a still image, such as zoom in on the image, zoom out from the image once having zoomed in, rotate the image, crop the image, etc. Furthermore, real time interface 106 may create a video clip from a plurality of still images. That is, video clips may optionally be created by real time interface 106 instead of or in addition to image capture subsystems 102. Real time interface 106 may allow a user to combine a plurality of still images to create a custom video clip. Real time interface 106 may be capable of automatically creating a video clip from a plurality of still images.

Some embodiments of real time interface 106 allow a user to obtain copies of one or more still images and/or video clips. Real time interface 106 optionally may be configured to require the user to purchase the copies. The copies may be provided, for example, in the form of a printed picture, a computer readable medium (e.g., compact or digital video disc) including an electronic copy of the still image and/or video clip, an email message including an electronic copy of the still image and/or video clip, or a link permitting the user to download an electronic copy of the still image and/or video clip. Real time interface 106 may deliver such copies to the user. Alternately, real time interface 106 may use an external system (e.g., a high resolution interface 108 discussed below) to fulfill the order.

The still images captured by image capture subsystems 102 may have a high resolution, and therefore each still image may have a relatively large file size. Accordingly, it may not be practical to transmit such high resolution still images (or video clips created from such still images) to real time interface 106 (if included in system 100) due to limitations of communications medium 104. Accordingly, in certain embodiments of system 100 that include real time interface 106, low resolution versions of captured still images and/or video clips created from such still images are transmitted to real time interface 106. In such embodiments, high resolution still images corresponding to the low resolution still images are accessed via an optional high resolution interface 108.

High resolution interface 108 allows access to high resolution versions of still images captured by image capture subsystems 102 and/or video clips created from such still images. However, unlike real time interface 106, high resolution interface 108 may, but does not necessarily, support real time or near real time access to still images and/or video clips.

High resolution still images and/or video clips from image capture subsystems 102 are provided to high resolution interface 108, for example, by a communication medium (not shown) connecting one or more of image capture subsystems 102 to high resolution interface 108. However, some embodiments of system 100 including high resolution interface 108 do not include such communication medium—in such embodiments, still images captured by image capture subsystems 102 and/or video clips created from such still images are stored on a medium (e.g., a computer storage backup tape or disk drive) that is physically transported from image capture subsystems 102 to the high resolution interface 108. For example, each image capture subsystem 102 may store high resolution captured still images on a computer storage medium. After the event concludes, such medium may be physically transferred to a data center hosting high resolution interface 108.

High resolution interface 108, for example, includes one or more of a web portal and a kiosk located at the event and allows a user to search (e.g., via a web browser) for still images and/or video clips that meet one or more criteria, such as participant identity, participant finish time, participant split time, and/or location within the event. High resolution interface 108 optionally is operable to allow a user to obtain (e.g., purchase) copies of still images and/or video clips that are delivered to the user in the form of, for example, a printed copy, an electronic file stored on a computer readable medium, an email message, and/or a hyperlink allowing the user to download a copy of a still image and/or video clip via the world wide web. Furthermore, high resolution interface 108 may be operable to allow a user to create a video clip and/or to automatically create a video clip from a plurality of still images. Thus, video clips may be created by high resolution interface 108 instead of, or in addition to, image capture subsystems 102.

If system 100 includes both high resolution interface 108 and real time interface 106, such two interfaces are optionally coupled together via a link 112. One advantage of linking real time interface 106 and high resolution interface 108 is that by doing so, the performance of a task can be shared by the two interfaces. Consider, for example, a situation where solely low resolution still images are delivered to real time interface 106, and real time interface 106 allows a user to purchase corresponding high resolution copies of the still images. In such situation, high resolution interface 108 could fulfill the user's purchase by providing high resolution copies of the still images selected by the user using real time interface 106.

Some embodiments of high resolution interface 108 do not include a user interface (e.g., a web portal). In such embodiments, high resolution interface 108 is accessed via another device (e.g., real time interface 106) in communication with high resolution interface 108. An embodiment of high resolution interface 108 not including a user interface, for example, supplies high resolution copies of still images and/or video clips to a web portal selling such still images and/or video clips.

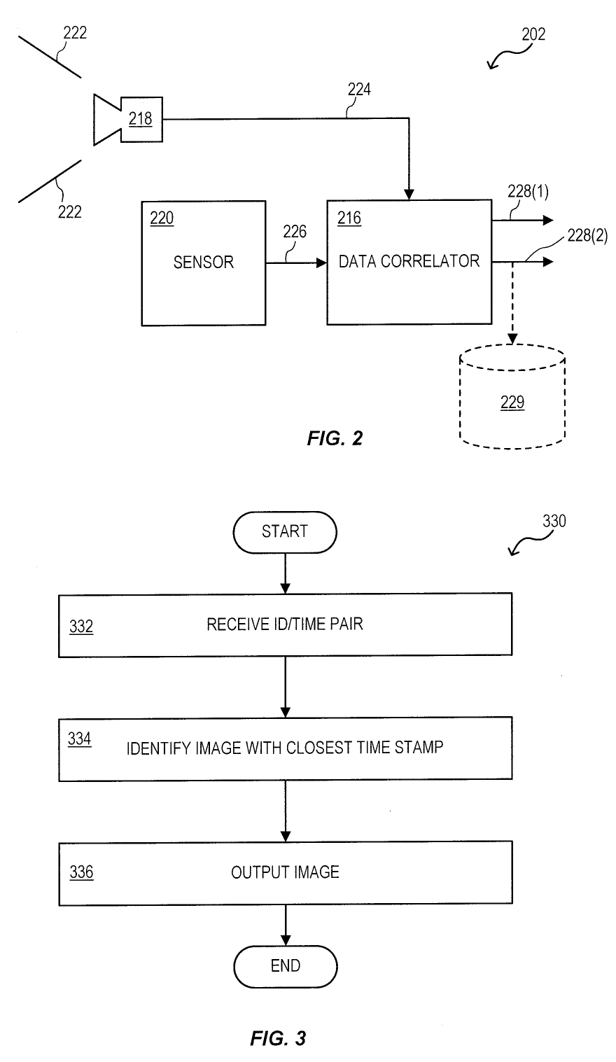

FIG. 2 schematically illustrates one image capture subsystem 202, which is an embodiment of image capture subsystem 102 of FIG. 1. Image capture subsystem 202 is advantageously operable to automatically correlate a captured still image to an identity of at least one object pictured in the image on a real time or near real time basis—such functionality is partially enabled by including a sensor 220 within image capture subsystem 202, as discussed below.

Image capture subsystem 202 includes at least one camera 218, a sensor 220, and a data correlator 216. Camera 218 is coupled to data correlator 216 via a communication medium 224, which is, for example, an Ethernet network. Each of camera 218, sensor 220, and data correlator 216 may be separate components. Alternately, one or more of camera 218, sensor 220, and data correlator 216 may be combined into a single package. For example, in one embodiment, camera 218 and data correlator 216 are combined into a common package, and sensor 220 is disposed in a separate package. In another embodiment, sensor 220 is integrated within camera 218.

Camera 218 is operable to periodically capture still images of scenes of interest within its field of view (represented by lines 222) and transfer these still images to data correlator 216. The still images, for example, have a JPEG format. Still images captured by camera 218 are time stamped either by data correlator 216 or by camera 218. Such stamped time, for example, is the time of day that camera 216 captured the image. If data correlator 216 performs the time stamping, data correlator 216 includes a clock that is, for example, synchronized with a clock of sensor 220. Alternately, if camera 218 performs the time stamping, camera 218 includes a clock that is, for example, synchronized with sensor 220's clock.

Sensors 220 provide identification/time pairs (“ID/time pairs”) to data correlator 216 via communication medium 226 (e.g., an Ethernet network). Such ID/time pairs include the identity of at least one object detected by sensor 220 and the time (e.g., time of day) that sensor 220 detected the at least one object. Ideally, sensor 220 and camera 218 should be cooperatively configured such that sensor 220 detects an object at the time the object is within camera 218's field of view. Sensor 220 includes, for example, at least one of a Radio Frequency Identification (“RFID”) timing system, a timing camera system (e.g., integrated within camera 218), a photoelectric timing system, and a tracking system for tracking event participants.

One example of a tracking system that may be included in sensor 220 is a system including a location unit for each participant and an object tracking device. Each participant is fitted with a location unit, and the object tracking device is operable to determine the locations of the location units. Accordingly, the object tracking device can determine a participant's location by locating the participant's respective location unit. Each location unit, for example, includes a global positioning system (“GPS”) receiver for determining the location unit's location and for transmitting such location to the object tracking device. As another example, each location unit may include a transceiver enabling the object tracking device to determine the location unit's position via triangulation.

In embodiments where image capture subsystem 202 is mobile, a current location of image capture subsystem 202 may be determined, for example, using a tracking system similar to one of the tracking systems discussed above for determining an event participant's location. Furthermore, in embodiments where image capture subsystem 202 is mobile, some embodiments of sensor 220 may be operable to determine an identity of at least one object in camera 218's field of view 222 based at least in part on a current location of the image capture subsystem. For example, some embodiments of sensor 220 may be operable to winnow down a set of possible identities of an object within camera 218's field of view 222 to identities of objects known to be in the vicinity of image capture subsystem 202's current location.

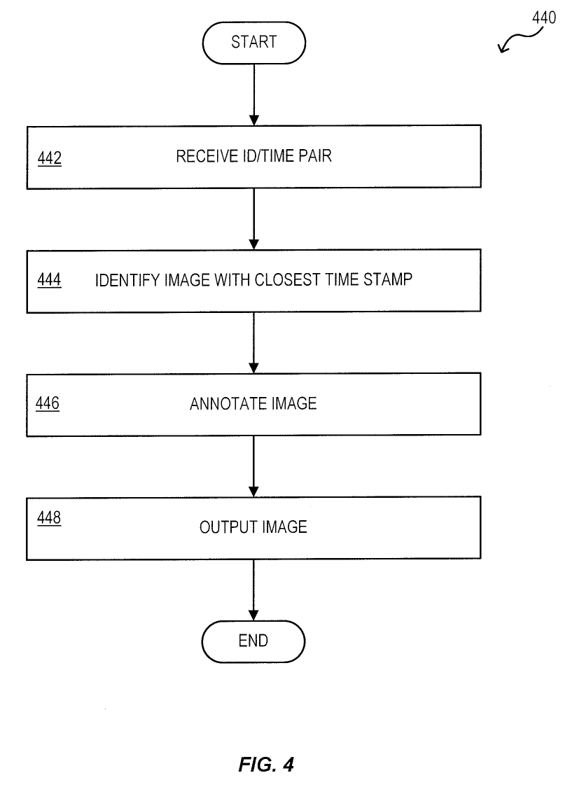

Data correlator 216, which may be embodied by a computer executing firmware or software (e.g., stored on a computer-readable medium), correlates a still image from camera 218 with the identity of at least one object pictured within the image. Data correlator 216, for example, performs such correlation upon receiving a request to provide an image corresponding to a specific ID/time pair by identifying an image having a time stamp that is closest in time to the time of the ID/time pair. Data correlator 216, for example, correlates a still image with the identity of an object pictured therein by executing one of methods 330 and 440 of FIGS. 3 and 4, respectively.

FIG. 3 is a flow chart of one method 330 for correlating a still image with the identity of an object pictured in the image. In step 332, an ID/time pair is received. An example of step 332 is data correlator 216 receiving an ID/time pair generated by sensor 220. In step 334, a still image having a time stamp that is closest in time to the time of the ID/time pair is identified. An example of step 334 is data correlator 216 identifying which image it received from camera 218 has a time stamp that is closest in time to the ID/time pair. In step 336, the image identified in step 334 is outputted. An example of step 336 is data correlator 216 outputting an image it identified in step 334 via an at least one output 228.

FIG. 4 is a flow chart of one method 440 for correlating a still image with the identity of an object pictured in the image. In step 442, an ID/time pair is received. An example of step 442 is data correlator 216 receiving an ID/time pair generated by sensor 220. In step 444, a still image having a time stamp that is closest in time to the time of the ID/time pair is identified. An example of step 444 is data correlator 216 identifying which image it received from camera 218 has a time stamp that is closest in time to the ID/time pair. In step 446, the image identified in step 444 is annotated with the identity information included in the ID/time pair. An example of step 446 is data correlator 216 annotating the image it identified in step 444 with the identity included in the ID/time pair. In step 448, the image identified in step 444 and annotated in step 446 is outputted. An example of step 448 is data correlator 216 outputting an image it identified in step 444 and annotated in step 446 via its at least one output 228.

Camera 218 (FIG. 2), for example, includes at least one of the following features: (a) the ability to capture still images at a variable frame rate (e.g., up to 30 frames per second), (b) the ability to capture a still image within a variable sized window (e.g., up to 2560×1920 pixels), and (c) the ability to control shutter speed (e.g., with a resolution of up to 1/0000^{th} of a second) independently of frame rate. The ability to control shutter speed independently of frame rate may advantageously allow the camera to capture high quality still images as the speed of an object pictured therein varies. The ability to adjust the camera's window size allows the flexibility to capture a very high resolution still image over a small field of view or capture a still image over a larger field of view with a reduced resolution.

In some embodiments of image capture subsystem 202, sensor 220 is operable to determine a speed of an object moving within camera 218's field of view 222. For example, sensor 220 may include an RFID timing system with two antennas spaced apart by a known distance. An object's speed may be determined from the time required for the object to travel between the two antennas. As another example, sensor 220 may include a timing camera that is operable to determine the speed of an object within the camera's field of view by determining a variation in the object's shape (e.g., determining a bicycle's speed by determining the extent that a wheel of the bicycle, which is known to be round, is not round). As yet, another example, sensor 220 may include a GPS system and/or a triangulation locating system that innately provides object speed information. However, embodiments of sensor 220 that are operable to determine an object's speed may use other speed detection methods known in the art.

In embodiments where sensor 220 is operable to determine a speed of an object moving within camera 218's field of view 222, camera 218's shutter speed may be automatically controlled as a function of the object's speed. For example, camera 218's shutter speed may be controlled to be directly proportional to the object's speed. In such embodiments, shutter speed would advantageously be only as fast as required by the object's speed. It may be advantageous to minimize shutter speed, for example, to maximize depth of field.

Some embodiments of camera 218 are operable to concurrently generate at least one corresponding still image from one captured still image, where the corresponding still image has a different resolution than the captured still image. For example, camera 218 may be operable to generate a first still image having a maximum resolution of camera 218 and a second corresponding still image having a lower resolution.

Data correlator 216 includes at least one output 228 for transferring time stamped and annotated still images to another component or system. For example, image capture subsystem 202 is illustrated in FIG. 2 as having output 228(1) for outputting low resolution still images and output 228(2) for outputting corresponding high resolution still images. The low and high resolution still images may be provided to data correlator 216 by camera 218—that is, data correlator 216 may simply pass the low and high resolution still images to outputs 228(1) and 228(2), respectively. Alternately, camera 218 may provide data correlator 216 a single high resolution still image, and data correlator 216 may include a resolution down sampler to generate one or more reduced resolution still images from the high resolution still image from camera 218.

Image capture subsystem 202 may optionally include one or more data storage subsystems 229 (e.g., hard drive or tape drive) connected to one or more of its outputs 228. For example, FIG. 2 illustrates data storage subsystem 229 optionally connected to output 228(2) to store high resolution still images, and such high resolution still images may be transferred from data storage subsystem 229 to high resolution interface 108 (FIG. 1).

Image capture subsystem 202 is optionally operable to compress the still images it captures. Such compression, for example, is performed by camera 218 and/or data correlator 216. Additionally, image capture subsystem 202 is optionally operable to create a video clip from a plurality of captured still images and output such video clip via its at least one output 228. Such video clip is created, for example, by data correlator 216 or camera 218. Furthermore, image capture subsystem 202 may be operable to annotate each still image with information identifying the particular image capture subsystem 202 that captured the image.

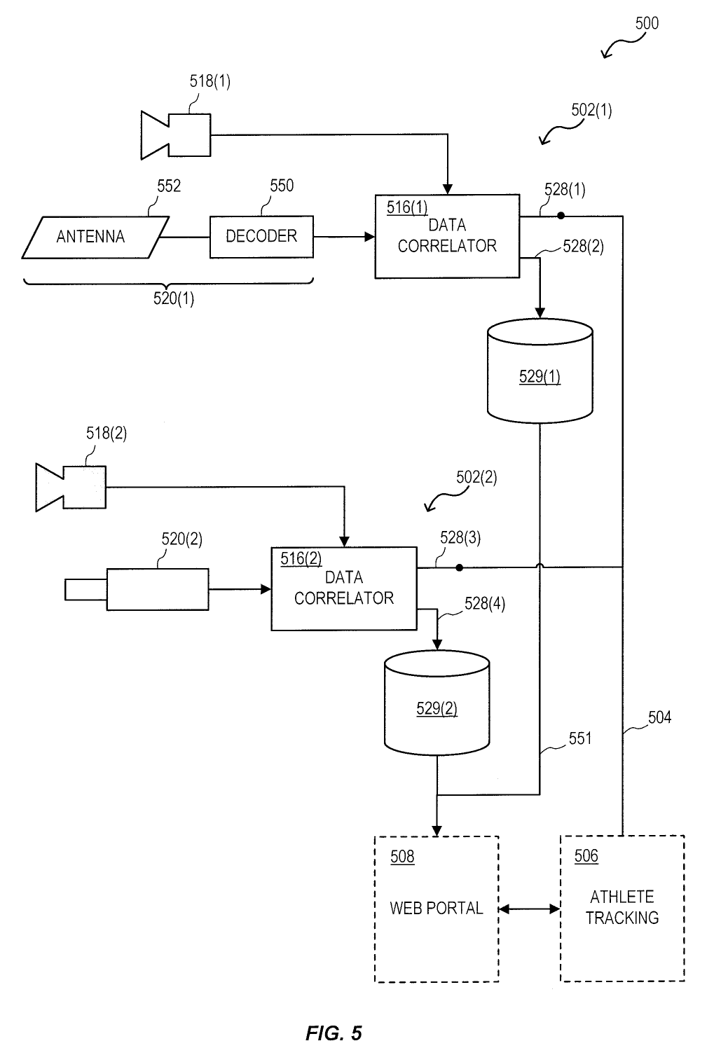

FIG. 5 schematically illustrates one system 500 for capturing images of an event, where system 500 is an embodiment of system 100 shown in FIG. 1. System 500 is illustrated as including two image capture subsystems 502(1) and 502(2); however, system 500 can include any number of image capture subsystems 502. Additionally, although image capture subsystems 502 are illustrated in FIG. 5 as being embodiments of image capture subsystem 202 of FIG. 2; image capture subsystems 502 may be other image capture subsystems. Furthermore, the configurations of sensors 520 may be varied from that illustrated in FIG. 5. For example, sensor 520(1) could be replaced with a sensor including a timing camera, and/or sensor 520(2) could be replaced with a sensor including an RFID timing system.

Image capture subsystem 502(1) includes a data correlator 516(1), a camera 518(1), and sensor 520(1), which are embodiments of data correlator 216, camera 218, and sensor 220 (FIG. 2), respectively. Sensor 520(1) includes an RFID timing system. In particular, sensor 520(1) includes an antenna 552 coupled to a decoder 550. Decoder 550 reads identification information from an RFID transponder worn by an event participant traveling in the vicinity of antenna 552 to generate an ID/time pair representing the participant's identity and the time decoder 550 recognized the participant. Data correlator 516(1) has outputs 528(1) and 528(2) for outputting low resolution and high resolution still images, respectively. The high resolution still images are for example stored in a data storage subsystem 529(1), which is coupled to output 528(2).

Image capture subsystem 502(2) includes a data correlator 516(2), a camera 518(2), and sensor 520(2), which are embodiments of data correlator 216, camera 218, and sensor 220 (FIG. 2), respectively. Sensor 520(2) includes a timing camera (e.g., a FinishLynx® line scan camera from Lynx System Developers, Incorporated) which is operable to generate ID/time pairs by capturing and analyzing still images of participants passing within the timing camera's field of view. Data correlator 516(2) has outputs 528(3) and 528(4) for outputting low and high resolution still images, respectively. The high resolution still images are for example stored in a data storage subsystem 529(2), which is coupled to output 528(4).

Low resolution outputs 528(1) and 528(3) are coupled to real time interface 506 via a communication medium 504, where real time interface 506 is an embodiment of real time interface 106 of FIG. 1. Real time interface 506 is operable, for example, to track an athlete in an event and display low resolution still images of the athlete as captured by image capture subsystems 502(1) and 502(2) and/or video clips formed of such still images.

System 500 further includes high resolution interface 508, which is an embodiment of high resolution interface 108 of FIG. 1. High resolution interface 508 receives high resolution still images from data storage subsystems 529. Communication medium 551 optionally connects data storage subsystems 529 to high resolution interface 508; alternately, still images are stored on one or more physical media at image storage subsystems 529, and such physical media are physically transported to high resolution interface 508 to make the still images available at interface 508. High resolution interface 508 is, for example, a web portal as illustrated in FIG. 5 which allows a user to access high resolution versions of still images captured by system 500 via the world wide web.

It should be noted that one or more image capture subsystems 502 may be partially combined. Specifically, data correlators 516 of two or more image capture subsystems 502 may be combined into a single apparatus. Such combination may be desirable if two or more image capture subsystems are disposed in close physical proximity to each other.

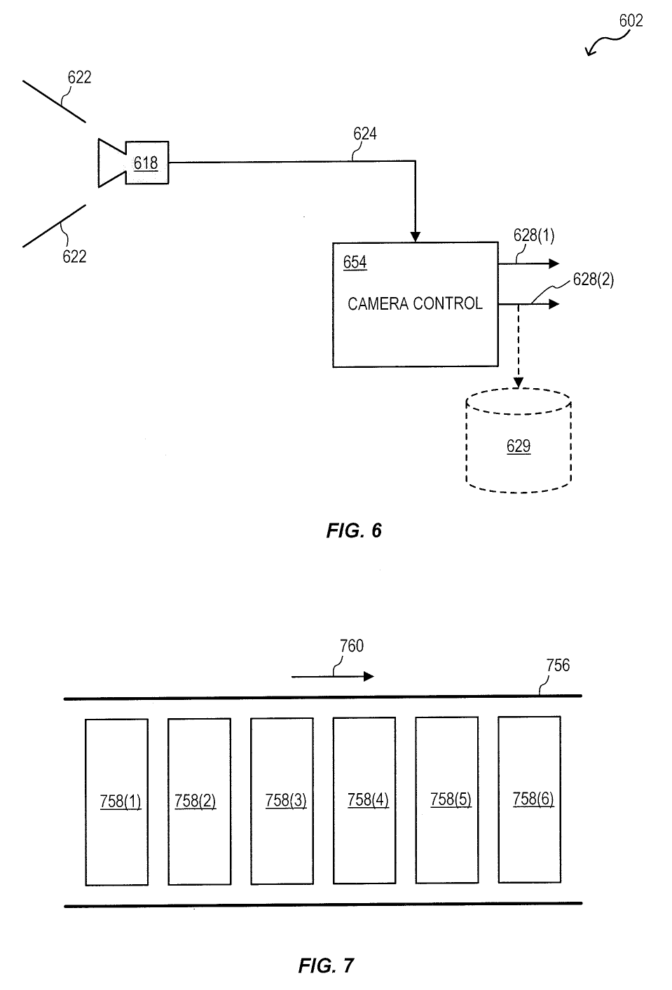

FIG. 6 schematically illustrates one image capture subsystem 602, which is an embodiment of image capture subsystem 102 of FIG. 1. Image capture subsystem 602 is operable to automatically capture still images of participants of an event and time stamp the images with their time of capture. However, unlike image capture subsystem 202 of FIG. 2, image capture subsystem 602 may be, but is not necessarily, operable to automatically correlate a still image to an identity of at least one object pictured therein. However, such correlation may be performed by an external data correlator (not illustrated in FIG. 6) by comparing time stamped still images from image capture subsystem 602 to ID/time pairs. For example, the external data correlator could identify an image having a time stamp closest in time to the time of a specific ID/time pair to correlate the image to an object identified by the ID/time pair. Such ID/time pairs may be generated, for example, by a sensor (not shown in FIG. 6) similar to that of sensor 220 of FIG. 2. As another example, the ID/time pairs may be manually created (e.g., in the form of a database or a spreadsheet), or may be created using a system having a pushbutton switch that creates an ID/time pair when an operator activates the switch in response to a participant passing a designated location (e.g., a race split point).

Image capture subsystem 602 includes at least one camera 618 having a field of view 622 and a camera control 654. Camera 618 is an embodiment of camera 218 of FIG. 2, and periodically captures still images within its field of view and transfers the still images to camera control 654 (e.g., in the form of JPEG files) via a communication medium 624. Communication medium 624 is, for example, an Ethernet network. Camera 618 may also be operable to determine if objects of interest (e.g., event participants 194 of FIG. 1) are within its field of view by using image analysis.

Some embodiments of camera 618 are operable to automatically determine a speed of an object within camera 618's field of view 622 and automatically adjust the camera's shutter speed as a function of the object's speed. For example, some embodiments of camera 618 are operable to determine an object's speed by determining a variation in the object's shape, as discussed above with respect to FIG. 2. As another example, camera 618 may include a radar or laser gun for measuring an object's speed.

Camera control 654, which may be embodied by a computer executing software or firmware (e.g., stored on a computer-readable medium), is, for example, operable to time stamp still images received from camera 618. Alternately, camera 618 may be operable to time stamp still images. Such stamped time, for example, is the time of day that camera 618 captured the image. The element that time stamps still images (i.e., camera control 654 or camera 618) must have a clock, and this clock is optionally synchronized with a clock used to time event participants (e.g., an official race clock if the event is a race). Synchronization of a clock in camera control 654 or camera 618 to another clock may be accomplished, for example, using a GPS where camera control 654 or camera 618 either has its own GPS receiver or is coupled to an external device (e.g., a server) that includes a GPS receiver. As another example, a clock in camera control 654 or camera 618 may operate independently, but such clock may be periodically (e.g., daily) manually synchronized with a clock associated with the event.

Camera control 654 includes at least one output 628 for outputting still images to an external system (e.g., real time interface 106 and/or high resolution interface 108 of FIG. 1). If camera control 654 has more than one output 628, each output may provide still images of the same scene but with different resolutions. For example, camera control 654 is illustrated as having output 628(1) for low resolution still images and output 628(2) for high resolution still images. If camera control 654 has more than one output 628, the plurality of corresponding still images may be generated directly by camera 618. Alternately, camera control 654 may generate one or more lower resolution still images from a high resolution still image from camera 618.

Image capture subsystem 602 may optionally include a data storage subsystem 629 (e.g., a hard drive or a tape drive) connected to one or more of its outputs 628. For example, FIG. 6 illustrates data storage subsystem 629 optionally connected to output 628(2) to store high resolution still images from camera 618. Such still images stored in data storage subsystem 629 may be transferred to high resolution interface 108 (FIG. 1).

Image capture subsystem 602 is optionally operable to compress some or all of its captured still images. Such compression is, for example, performed by camera 618 and/or camera control 654. Furthermore, if all desired functionality of image capture subsystem 602 is present in camera 618, camera control 654 may not be required. Additionally, image capture subsystem 602 is optionally operable to create a video clip from a plurality of captured still images and output the video clip via its at least one output 628. Such video clip is, for example, created by camera control 654 or camera 618. Furthermore, image capture subsystem 602 may be operable to annotate each still image with information identifying the particular image capture subsystem 602 that captured the still image.

Some embodiments of image capture subsystem 102 (FIG. 1) are optionally operable to discard some or all still images that do not include an object of interest pictured therein. Such embodiments may be referred to as having an image discard feature. For example, in the road race example illustrated in FIG. 1, image capture subsystems 102 may be optionally be capable of discarding still images that do not include a participant 194. The image discard feature may advantageously prevent the processing, storing, and/or transmitting of captured still images of little or no particular value.

Embodiments of image capture subsystems 102 having the image discard feature include a buffer for temporarily storing recently captured still images. Specifically, in embodiments of image capture subsystem 202 having the image discard feature, the buffer may be located within data correlator 216 or camera 218. In embodiments of image capture subsystem 602 including the image discard feature, the buffer may be located within camera control 654 or camera 618.

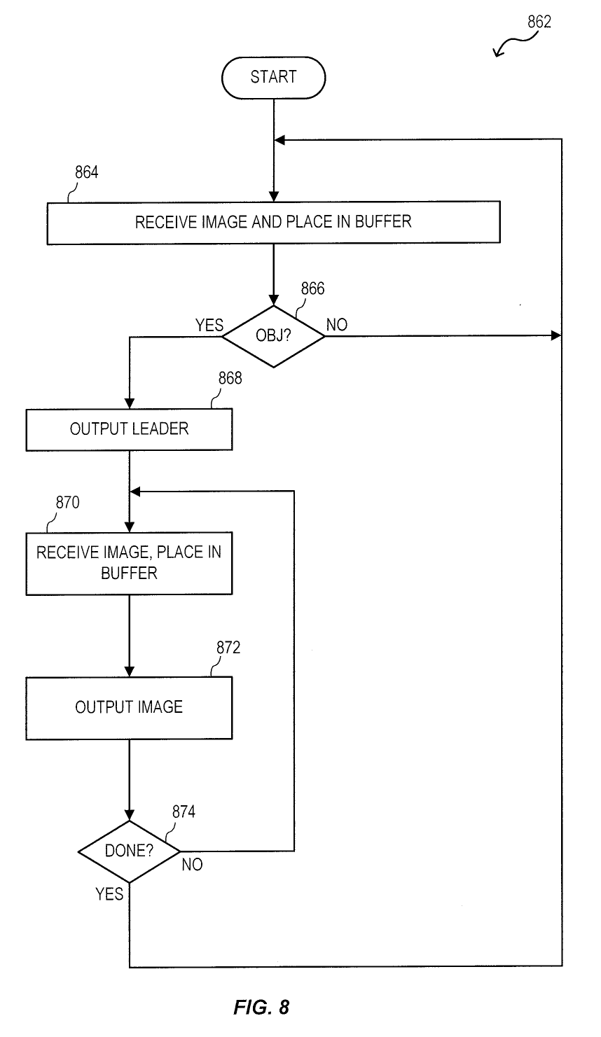

FIG. 7 is block diagram illustrating one example of a buffer 756 that can be included in embodiments of image capture subsystem 102 to implement the image discard feature. Buffer 756, which holds a plurality of still images 758, can be considered to function similarly to a pipeline—still images 758 flow through buffer 756 in the direction of arrow 760. Whenever a new still image (e.g., still image 758(1)) is to be placed in buffer 756, each still image in the pipeline advances one position in the direction of arrow 760, and still image 758(6), which has been within buffer 756 for the longest amount of time, exits buffer 756.

Buffer 756 may be configured to store a predetermined quantity of still images. For example, FIG. 7 illustrates buffer 756 as configured to store six still images 758. Alternately, buffer 756 may be configured to store still images captured over a predetermined time period (e.g., all still images captured within the last 5 seconds).

FIG. 8 illustrates one method 862 for controlling the output of captured still images. Method 862 limits the output of still images not including an object of interest, thereby effectively discarding some still images not including an object of interest.

In step 864, a new still image is received and placed in a buffer. One example of step 864 is data correlator 216 of image capture subsystem 202 (FIG. 2) receiving a still image from camera 218 and placing the still image within a buffer of data correlator 216. Another example of step 864 is camera control 654 of image capture subsystem 602 (FIG. 6) receiving a still image from camera 618 and placing the image within a buffer of camera control 654.

In decision step 866, it is determined whether the still image received in step 864 includes an object of interest pictured therein. If yes, method 862 proceeds to step 868; if no, method 862 returns to step 864. An example of decision step 866 is data correlator 216 of image capture subsystem 202 determining that a still image includes an object of interest solely if the still image has a time stamp closest in time to a time stamp specified in an ID/time pair. Another example of decision step 866 is camera controller 654 of image capture subsystem 602 determining that a still image includes an object of interest, solely if camera 618 indicates that the still image contains an object of interest.

In step 868, copies of all still images stored in the buffer, which may be considered the “leader” to the still image received in step 864, are sequentially outputted. Thus, the size of the buffer determines the size of the leader. It may be desirable to have a long leader (measured either by number of still images or by time duration) if an object of interest is expected to be within the image capture subsystem's field of view for a significant amount of time before the object's detection. It should be noted that in step 868, mere copies of still images stored within the buffer are outputted; the contents of the buffer are not disturbed. An example of step 868 is data correlator 216 outputting the contents of a buffer of image capture subsystem 202 to its at least one output 228. Another example of step 868 is camera control 654 outputting the contents of a buffer of image capture subsystem 602 to its at least one output 628.

In step 870, a new still image is received and placed in the buffer. An example of step 870 is data correlator 216 receiving a new still image and placing it in a buffer. Another example of step 870 is camera control 654 receiving a still image and placing it in a buffer.

The still image received in step 870 is outputted in step 872. An example of step 872 is data correlator 216 outputting a still image received from camera 218 to its one or more outputs 228. Another example of step 872 is camera control 654 outputting a still image received from camera 618 to its one or more outputs 628.

In decision step 874, it is determined whether all still images in a “trailer” have been outputted. In contrast to the leader discussed above, the trailer is a predetermined quantity of still images or images captured within a predetermined amount of time (e.g., 5 seconds) that are received after the still image received in step 864. Accordingly, the trailer is a series of still images captured after the capture of a still image including an object of interest. It may be desirable to have a long trailer (as characterized by a number of still images or by a time duration) if an object of interest is expected to remain within the image capture subsystem's field of view for a significant period after its recognition.

If the result of decision step 874 is yes, the entire trailer has been outputted, and method 862 returns to step 864. If the result of decision step 874 is no, the entire trailer has not been outputted, and method 862 returns to step 870. An example of step 874 is data correlator 216 determining whether all still images, captured by camera 218 in the 5 seconds following the capture of the still image received in step 864, have been outputted. Another example of step 870 is camera control 654 determining whether all still images captured by camera 618 in the 5 seconds following the capture of the still image received in step 864 have been outputted.

Thus, method 862 is operable to limit the output of image capture subsystems to still images including an object of interest pictured therein and leaders and trailers associated with such still images.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A system for capturing images of an event, comprising at least one data correlator, the data correlator being operable to:
receive still images captured by a camera and to receive identification/time pairs from a sensor, each identification/time pair including an identity of at least one respective object and a time that the at least one respective object was within the camera's field of view, and
automatically correlate the still images with identities of respective objects included in the still images by correlating an identity of at least one respective object of each identification/time pair to a still image that is closest in time to a time of the identification/time pair.

2. The system of claim 1, further comprising a real time interface for allowing a user to access the still images in real time.

3. The system of claim 2, the real time interface being operable to allow a user to search for still images including an object of interest.

4. The system of claim 2, the real time interface being operable to allow a user to create a video clip from a plurality of the still images.

5. The system of claim 2, the real time interface being operable to automatically create a video clip from a plurality of the still images.

6. A system for capturing images of an event, comprising at least one image capture subsystem, each image capture subsystem including:
a camera having a field of view for periodically capturing still images within the camera's field of view;
a sensor for detecting objects within the camera's field of view and for generating a respective identification/time pair for each detected object, each identification/time pair including an identity of a respective object and a time that the sensor detected the respective object; and
a data correlator coupled to the camera and the sensor, the data correlator being operable to receive the still images captured by the camera and the identification/time pairs generated by the sensor, the data correlator operable to automatically correlate the still images with identities of respective objects included in the still images by correlating an identity of each identification/time pair to a still image that is closest in time to a time of the identification/time pair.

7. The system of claim 6, the data correlator being operable to time stamp the still images captured by the camera.

8. The system of claim 7, the data correlator having a first clock and the sensor having a second clock, the first clock being synchronized with the second clock.

9. The system of claim 6, the camera being operable to time stamp each still image captured by the camera.

10. The system of claim 9, the camera having a first clock and the sensor having a second clock, the first clock being synchronized with the second clock.

11. The system of claim 6, the camera being coupled to the data correlator by an Ethernet network.

12. The system of claim 6, the still images captured by the camera having a JPEG format.

13. The system of claim 6, the sensor including a Radio Frequency Identification (“RFID”) timing system.

14. The system of claim 6, the sensor including a timing camera.

15. The system of claim 6, the camera having a variable shutter speed and a variable frame rate, the shutter speed being adjustable independently of the frame rate.

16. The system of claim 15, the sensor being operable to detect a speed of an object moving within the camera's field of view, and the camera's shutter speed being adjusted according to the speed of the object.

17. The system of claim 6, the camera having a variable window size.

18. The system of claim 6, the camera being operable to generate at least one corresponding still image from each captured still image, the corresponding still image having a different resolution than the captured still image.

19. The system of claim 6, the camera being operable to compress the still images captured by the camera.

20. The system of claim 6, further comprising a real time interface for allowing a user to access in real time still images captured by the at least one image capture subsystem.

21. The system of claim 20, the real time interface being a kiosk.

22. The system of claim 20, the real time interface being a web portal.

23. The system of claim 20, the real time interface being a telecommunications network.

24. The system of claim 20, the real time interface being a display.

25. The system of claim 20, the real time interface being operable to allow a user to create a video clip from a plurality of still images captured by the at least one image capture subsystem.

26. The system of claim 20, the real time interface being operable to automatically create a video clip from a plurality of still images captured by the at least one image capture subsystem.

27. The system of claim 20, further comprising a high resolution interface for accessing high resolution still images captured by the at least one image capture subsystem.

28. The system of claim 27, the high resolution interface being a kiosk.

29. The system of claim 27, the high resolution interface being a web portal.

30. The system of claim 27, the high resolution interface being operable to allow a user to create a video clip from a plurality of still images captured by the at least one image capture subsystem.

31. The system of claim 27, the high resolution interface being operable to automatically create a video clip from a plurality of still images captured by the at least one image capture subsystem.

32. The system of claim 6, the at least one image capture subsystem further comprising a buffer for temporarily storing still images captured by the image capture subsystem.

33. The system of claim 32, data correlator being operable to discard still images that do not contain an object of interest.

34. The system of claim 6, at least one image capture subsystem being operable to create a video clip from a plurality of still images captured by the image capture subsystem's camera.

35. The system of claim 6, further comprising a plurality of image capture subsystems.

36. A method for correlating a still image with an identity of an object pictured in the still image, comprising the steps of:
receiving an identification/time pair including the object's identity and a time that the object was detected by a sensor;
identifying a respective still image having a time stamp closest in time to the time of the identification/time pair; and
outputting the identified still image.

37. The method of claim 36, further comprising annotating the identified still image with the object's identity before the step of outputting.

38. A software product comprising instructions, stored on a computer-readable medium, wherein the instructions, when executed by a computer, perform steps for correlating a still image with an identity of an object pictured in the still image, the steps comprising:
receiving an identification/time pair including the object's identity and a time that the object was detected by a sensor;
identifying a respective still image having a time stamp closest in time to the time of the identification/time pair; and
outputting the identified still image.
